(19) United States
(12) Patent Application Publication
(10) Pub. No.: US 2025/0240288 A1
(43) Pub. Date: Jul. 24, 2025

(54) OPERATING STORAGE EQUIPMENT VIA TRUSTED CONNECTIVITY

(71) Applicant: Dell Products L.P., Round Rock, TX (US)

(72) Inventors: Anil C. Kumar, Norton, MA (US); John P. Marchese, JR., East Hampton, CT (US)

(21) Appl. No.: 18/420,889

(22) Filed: Jan. 24, 2024

(51) Int. Cl. H04L 9/40; H04L 67/1097

(52) U.S. Cl. CPC H04L 63/0838; H04L 63/20; H04L 67/1097

(57) ABSTRACT

Techniques to operate storage equipment involve, in response to a startup command, registering the storage equipment as an untrusted client at a data center through first connectivity between a connectivity client embedded within the storage equipment and the data center. The connectivity client obtains a set of temporary credentials while registering. The techniques further involve establishing second connectivity between the connectivity client and the data center based on the set of temporary credentials, the second connectivity providing stronger security than the first connectivity. The techniques further involve, after establishing the second connectivity between the connectivity client and the data center, providing trusted communications between the connectivity client and the data center through the second connectivity to manage the storage equipment.

### BACKGROUND

Data storage systems operate by writing data into and reading data from storage devices in response to input/output (I/O) requests. In some situations, such data storage systems reside at customer locations (e.g., on the customers' premises). In other situations, such data storage systems reside at locations that are remote from the customer (e.g., within scalable infrastructure in the cloud).

When customers acquire access to such data storage systems, the customers may wish to obtain certain services and/or perform certain specialized operations. For example, a customer may wish to enroll a data storage system with a program that enables the customer to download and install certain software applications and/or software updates through the Internet. As another example, a customer may want to procure remote third-party expertise to fix a data storage system problem. As yet another example, a customer may wish to simply hire an external service to remotely monitor and manage the customer's entire data storage system.

### SUMMARY

Unfortunately, there are deficiencies to conventional data storage systems in which customers wish to obtain certain services and/or perform certain specialized operations. Along these lines, such activities typically involve connectivity between the data storage systems and remote entities that provide the specialized services/operations. However, such connectivity is often created inconsistently and may not be secure. Accordingly, the data storage systems may experience communication difficulties, may be vulnerable to hacking or inadvertently disclose information, may provide limitations as to the level of remote management that can be provided, and so on.

Improved techniques are directed to operating storage equipment which involve establishing and utilizing trusted connectivity between the storage equipment and a data center. Such trusted connectivity is formed in response to registration (e.g., issuance of a set of temporary credentials, using the set of temporary credentials in an exchange to establish zero trust connectivity, etc.). Once such trusted connectivity is established, the data center is able to carry out a variety of rich and reliable operations such as deploying software/updates/etc., performing user operations, monitoring/evaluating storage equipment telemetry, storage equipment troubleshooting, and so on via the trusted connectivity.

One embodiment is directed to a method of operating storage equipment. The method includes, in response to a startup command, registering the storage equipment as an untrusted client at a data center through first connectivity between a connectivity client embedded within the storage equipment and the data center. The connectivity client obtains a set of temporary credentials while registering. The method further includes establishing second connectivity between the connectivity client and the data center based on the set of temporary credentials, the second connectivity providing stronger security than the first connectivity. The method further includes, after establishing the second connectivity between the connectivity client and the data center, providing trusted communications between the connectivity client and the data center through the second connectivity to manage the storage equipment.

Another embodiment is directed to storage equipment which includes a set of storage devices constructed and arranged to store data, and storage equipment circuitry coupled with the set of storage devices. The storage equipment circuitry is constructed and arranged to provide a connectivity client and perform a method of:
(A) in response to a startup command, registering the storage equipment as an untrusted client at a data center through first connectivity between the connectivity client and the data center, the connectivity client obtaining a set of temporary credentials while registering;
(B) establishing second connectivity between the connectivity client and the data center based on the set of temporary credentials, the second connectivity providing stronger security than the first connectivity; and
(C) after establishing the second connectivity between the connectivity client and the data center, providing trusted communications between the connectivity client and the data center through the second connectivity to manage the storage equipment.

Yet another embodiment is directed to data center equipment which includes a set of management servers constructed and arranged to manage storage equipment, and data center circuitry coupled with the set of management servers. The data center circuitry is constructed and arranged to perform a method of:
(A) in response to a startup command, registering the storage equipment as an untrusted client at the data center through first connectivity between a connectivity client embedded within the storage equipment and the data center, the connectivity client obtaining a set of temporary credentials while registering;
(B) establishing second connectivity between the connectivity client and the data center based on the set of temporary credentials, the second connectivity providing stronger security than the first connectivity; and
(C) after establishing the second connectivity between the connectivity client and the data center, providing trusted communications between the connectivity client and the data center through the second connectivity to enable the set of management servers to manage the storage equipment.

Furthermore, another embodiment is directed to a computer program product having a non-transitory computer readable medium which stores a set of instructions to operate storage equipment. The set of instructions, when carried out by computerized circuitry, causes the computerized circuitry to perform a method of:
(A) in response to a startup command, registering the storage equipment as an untrusted client at a data center through first connectivity between a connectivity client embedded within the storage equipment and the data center, the connectivity client obtaining a set of temporary credentials while registering;
(B) establishing second connectivity between the connectivity client and the data center based on the set of temporary credentials, the second connectivity providing stronger security than the first connectivity; and
(C) after establishing the second connectivity between the connectivity client and the data center, providing trusted communications between the connectivity client and the data center through the second connectivity to manage the storage equipment.

In some arrangements, the data center includes a storefront server. Additionally, the first connectivity includes a first connection between the connectivity client and the storefront server. Furthermore, registering the storage equipment as an untrusted client at the data center through the first connectivity includes delivering a temporary identifier and a temporary certificate from the storefront server to the connectivity client through the first connection between the connectivity client and the storefront server of the data center.

In some arrangements, the data center further includes a set of management servers that is different from the storefront server. Additionally, establishing the second connectivity includes creating, as at least part of the second connectivity, a second connection between the connectivity client and the set of management servers of the data center, the second connection being different from the first connection.

In some arrangements, creating the second connection between the connectivity client and the set of management servers of the data center includes, based on the set of temporary credentials obtained by the connectivity client while registering, performing handshaking and validation operations between the connectivity client and the set of management servers to form a trusted connection as the second connection.

In some arrangements, providing the trusted communications between the connectivity client and the data center includes deploying storage equipment software from the set of management servers to the storage equipment through the trusted connection and the connectivity client, the storage equipment software being constructed and arranged to install and operate on the storage equipment to process input/output (I/O) requests on behalf of a set of host computers.

In some arrangements, providing the trusted communications between the connectivity client and the data center includes providing a set of user commands from the set of management servers to the storage equipment through the trusted connection and the connectivity client, the set of user commands being constructed and arranged to create a set of storage objects which hold host data on the storage equipment.

In some arrangements, providing the trusted communications between the connectivity client and the data center includes conveying storage equipment performance metrics from storage equipment to the set of management servers through the connectivity client and the trusted connection, the storage equipment performance metrics identifying operating details of the storage equipment.

In some arrangements, providing the trusted communications between the connectivity client and the data center includes performing storage equipment troubleshooting operations on the storage equipment from the set of management servers through the trusted connection and the connectivity client, the storage equipment troubleshooting operations being constructed and arranged to diagnose and remediate anomalies on the storage equipment.

In some arrangements, the storage equipment is disposed at a storage equipment location. Additionally, the data center resides at a set of remote locations that is different from the storage equipment location. Furthermore, the connections extend over a public network that connects the storage equipment location with the set of remote locations. Also, providing the trusted communications between the connectivity client and the data center includes electronically managing the storage equipment from the data center through at least some of the connections that extend over the public network.

In some arrangements, the storage equipment includes:
(i) primary storage processing circuitry which includes an operating instance of the connectivity client, and
(ii) secondary storage processing circuitry which includes a backup instance of the connectivity client to enable the connectivity client to continue operation in response to a failover event in which the primary storage processing circuitry encounters a failure while the secondary storage processing circuitry remains operational and the backup instance of the connectivity client takes over on behalf of the operating instance of the connectivity client.

In some arrangements, the storage equipment includes:
(i) a set of storage data server (SDS) nodes, and
(ii) a management platform coupled with the set of SDS nodes, the management platform including the connectivity client and being constructed and arranged to run a set of containerized applications to store data within the set of SDS nodes on behalf of a set of host computers.

In some arrangements, registering the storage equipment as an untrusted client at the data center through the first connectivity further includes:
(i) conveying an installation token from the connectivity client from the storefront server to the set of management servers,
(ii) based on the installation token, generating the temporary identifier and the temporary certificate in the set of management servers, and
(iii) conveying the temporary identifier and the temporary certificate from the set of management servers to the storefront server for delivery from the storefront server to the connectivity client.

In some arrangements, registering the storage equipment as an untrusted client at the data center through the first connectivity further includes, prior to delivering the temporary identifier and the temporary certificate from the storefront server to the connectivity client, storing the temporary identifier and the temporary certificate in the set of management servers to enable the set of management servers to perform the handshaking and validation operations to form the trusted connection.

In some arrangements, the method further includes, prior to registering the storage equipment as an untrusted client at the data center, installing and activating the connectivity client on the storage equipment.

It should be understood that, in the cloud context, at least some electronic circuitry is formed by remote computer resources distributed over a network (e.g., hosts, management equipment, scalable storage resources, etc.). Such an electronic environment is capable of providing certain advantages such as high availability and data protection, transparent operation and enhanced security, big data analysis, etc.

Other embodiments are directed to electronic systems and apparatus, processing circuits, computer program products, and so on. Some embodiments are directed to various methods, electronic assemblies, components and circuitry which are involved in operating (or managing) storage equipment via trusted connectivity.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a block diagram of an electronic setting in which a connectivity client embedded within storage equipment is able to establish and utilize trusted connectivity with a data center in accordance with certain embodiments.

FIG. 2 is a sequence diagram showing certain activities in accordance with certain embodiments.

FIG. 3 is a block diagram of a first example storage platform which is suitable for certain embodiments.

FIG. 4 is a block diagram of a second example storage platform which is suitable for certain embodiments.

FIG. 5 is a flowchart of a procedure to operate storage equipment in accordance with certain embodiments.

### DETAILED DESCRIPTION

An improved technique is directed to operating storage equipment which involves establishing and utilizing trusted connectivity between the storage equipment and a data center. Such trusted connectivity is formed in response to registration (e.g., providing a set of temporary credentials, using the set of temporary credentials in an exchange to establish zero trust connectivity, etc.). Once such trusted connectivity is in place, the data center is able to carry out a variety of rich and reliable operations such as deploying software/updates/etc., performing user operations, monitoring/evaluating telemetry, troubleshooting, and so on via the trusted connectivity.

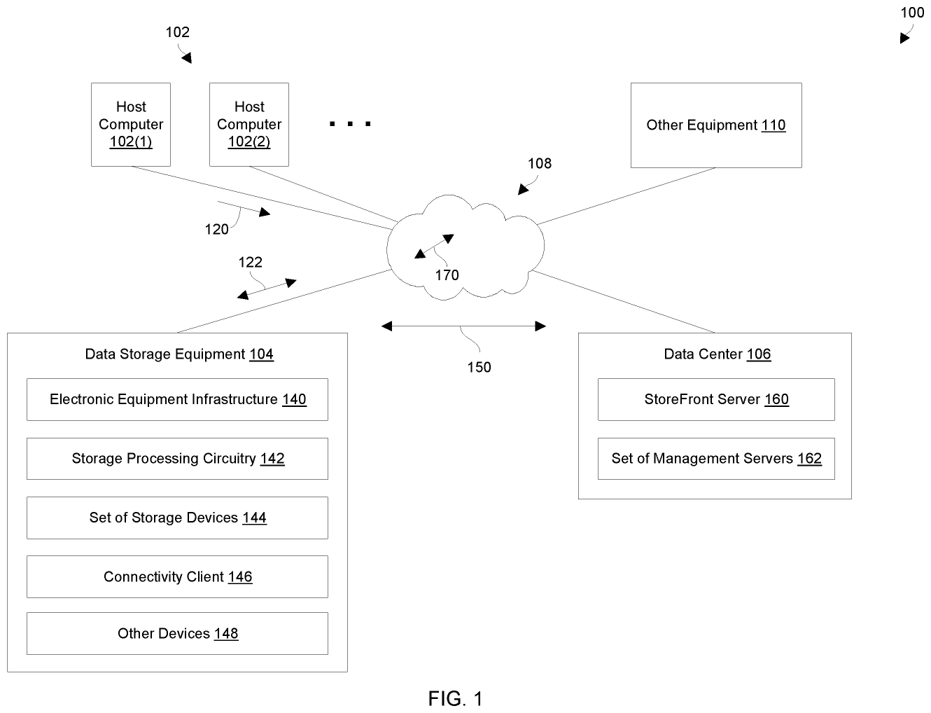

FIG. 1 shows an electronic setting 100 in which storage equipment is operated (or managed) via trusted connectivity in accordance with certain embodiments. As will be explained in further detail below, the electronic setting 100 includes a connectivity client embedded within storage equipment which is able to establish and utilize trusted connectivity with a data center.

By way of example, the electronic setting 100 is a data storage environment that includes host computers 102(1), 102(2), . . . (collectively, host computers 102), data storage equipment 104, a data center 106, a communications medium 108, and perhaps other equipment 110. Other environments are suitable for use as well such as general purpose computing environments, server farms, cloud-based systems, enterprise/corporate computing/infrastructure equipment, retail settings, manufacturing settings, government settings, specialized service providers, academic settings, websites, environments for specialized operations, combinations thereof, and so on.

Each host computer 102 is constructed and arranged to perform useful work. For example, one or more of the host computers 102 may operate as a file server, a web server, an email server, an enterprise server, a database server, a transaction server, combinations thereof, etc. which provides host input/output (I/O) requests 120 to the data storage equipment 104. In this context, the host computers 102 may provide a variety of different I/O requests 120 (e.g., block and/or file based write commands, block and/or file based read commands, combinations thereof, etc.) that direct the data storage equipment 104 to store host data 122 within and retrieve host data 122 from storage (e.g., primary storage or main memory, secondary storage, tiered storage, combinations thereof, etc.).

The data storage equipment 104 is an example of electronic equipment that is capable of being remotely operated/managed at least to an extent by a data center. The data storage equipment 104 includes an electronic equipment infrastructure 140, storage processing circuitry 142, a set of storage devices 144, a connectivity client 146, and other devices 148.

The electronic equipment infrastructure 140 is constructed and arranged to support operation of various components of the data storage equipment 104. To this end, the electronic equipment infrastructure 140 positions the various components relative to each other, conveys power signals from power converters to the various components, positions fans along air pathways to provide cooling to the various components (i.e., to remove heat), protects the various components against tampering, damage, and so on. Along these lines, the electronic equipment infrastructure 140 may include one or more frames or card cages, chassis/housings/cabinets, power supplies/converters, fans, backplanes or midplanes, and so on.

The storage processing circuitry 142 is constructed and arranged to respond to the host I/O requests 120 received from the host computers 102 by writing data into the set of storage devices 144 and reading the data from the set of storage devices 144. The storage processing circuitry 142 may include one or more physical storage processing modules or engines, data movers, director boards, blades, etc. In accordance with certain embodiments, the storage processing circuitry 142 may include a variety of specialized subcomponents such as processing circuitry to process I/O requests 120 from the host computers 102, cache memory to operate as read and/or write caches, on-board NICs to provide communications between the storage processing circuitry 142 and/or external devices, LEDs and switches for local I/O, and so on.

In some arrangements, the storage processing circuitry 142 may be constructed and arranged to provide a virtualized environment (e.g., to support virtual machines, virtual data movers or VDMs, etc.). Along these lines, the data storage equipment 104 may take the form a scalable infrastructure which uses containers and provides microservices (e.g., a Kubernetes clustered environment).

As will be explained in further detail shortly, while the storage processing circuitry 142 processes the host I/O requests 120, the storage processing circuitry 142 utilizes trusted connectivity 150 with the data center 106 (see the double arrow 150) for certain operations. Example operations include software installation/updates, carrying out user operations remotely, monitoring and evaluating telemetry, troubleshooting, combinations thereof, and so on.

The set of storage devices 144 is constructed and arranged to store data within the data storage equipment 104. In accordance with certain embodiments, the set of storage devices 44 may arrange the data in accordance with one or more data protection schemes (e.g., RAID1, RAID5, RAID6, RAID10, etc.). Example storage devices 144 include RAM devices, NVRAM devices, other solid state memory devices (SSDs), hard disk drives (HDDs), combinations thereof, and so on.

The connectivity client 146 is specialized circuitry which communicates with the data center 106 to establish and utilize the trusted connectivity 150. Trusted communications through the trusted connectivity 150 ensures that communications between the data storage equipment 104 and the data center are rich, reliable, and secure. Along these lines, through such trusted connectivity, the data center 150 is able to provide software, updates, commands, etc. as well as monitor and evaluate events, performance, problems, etc. Accordingly, the level of remote management may be just as good or even exceed that of on premises management in terms of timeliness, cost, quality, and so on.

It should be understood that the connectivity client 146 is shown in FIG. 1 by way of example as being external to the storage processing circuitry 142 (e.g., as circuitry that is separate from the storage processing circuitry 142). However, in some arrangements, the connectivity client 146 is integrated with (or resides within) the storage processing circuitry 142 (e.g., the connectivity client 146 is formed by the processing circuitry that also operates as the storage processing circuitry 142).

The other devices 148 of the data storage equipment 104 are constructed and arranged to provide supporting features. Along these lines, the other devices 148 may include a set of communications interfaces (e.g., a set of network interface controllers or NICs) that provide communications for the data storage equipment 104, a user interface for local user access, backup power sources, and so on.

The data center 106 is constructed and arranged to establish the trusted connectivity 150 with the data storage equipment 104 and then provide services remotely. In particular, the data center 106 is able to register the data storage equipment 104 in a manner which establishes the trusted connectivity 150, and then operate (or manage) the data storage equipment 104 through the trusted connectivity 150.

As shown in FIG. 1, the data center 150 includes a storefront server 160 and a set of management servers 162 (i.e., one or more management servers 162). The storefront server 160 is constructed and arranged to respond to an initial communication from the data storage equipment 104 to register (or enroll) the data storage equipment 104 to establish the trusted connectivity 150. The set of management servers 162, which is coupled with the storefront server 160, is constructed and arranged to complete establishment of the trusted connectivity 150, and then communicate with the data storage equipment 104 through the trusted connectivity 150 (e.g., to deploy software/updates/etc., perform user operations, monitor/evaluate telemetry, troubleshoot, combinations thereof, etc.).

In some arrangements, the storefront server 160 serves as a common front entrance (or entryway) for multiple data storage equipment installations to initiate contact with the data center 106 and/or use as a registration portal. Accordingly, there may be other instances of data storage equipment 104 and such instances originate communications with the storefront server 160 of the data center 106.

In some arrangements, the set of management servers 162 perform backend processing after communications have been initiated with the storefront server 160. Along these lines, the set of management servers 108 may perform critical operations such as handshaking, validation, authentication, etc. to establish respective trusted connectivity 150 with the various instances of data storage equipment 104 (i.e., the electronic setting 100 may include multiple data storage equipment 104 installations which establish respective trusted connectivity 150), as well as subsequent storage management operations (e.g., software installs/updates, user operations such as creating and configuring volumes and other storage objects, telemetry monitoring/evaluating, troubleshooting, combinations thereof, etc.).

The communications medium 108 is constructed and arranged to connect the various components of the electronic setting 100 together to enable these components to exchange electronic signals 170 (e.g., see the double arrow 170). As will be explained in further detail shortly, the trusted connectivity 150 which is established between the data storage equipment 104 and the data center 106 is through the communications medium 108. At least a portion of the communications medium 108 is illustrated as a cloud to indicate that the communications medium 108 is capable of having a variety of different topologies including backbone, hub-and-spoke, loop, irregular, combinations thereof, and so on. Along these lines, the communications medium 108 may include copper-based data communications devices and cabling, fiber optic devices and cabling, wireless devices, combinations thereof, etc. Furthermore, the communications medium 108 is capable of supporting LAN-based communications, SAN-based communications, cellular communications, WAN-based communications, distributed infrastructure communications, other topologies, combinations thereof, etc.

The other equipment 110 represents other possible componentry of the electronic setting 100. Along these lines, the other equipment 110 may include remote data storage equipment that provides data to and/or receives data from the data storage equipment 104 (e.g., replication arrays, backup and/or archiving equipment, external service processors and/or other management/control devices, etc.).

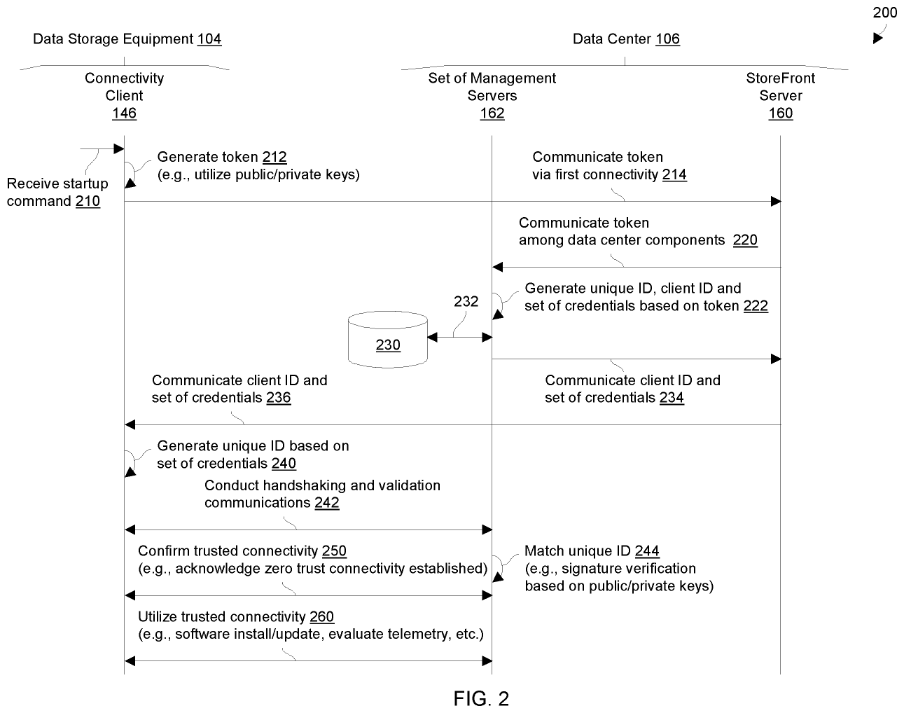

During operation, the data storage equipment 104 processes I/O requests 120 from the set of host computers 102 to perform useful work. In particular, the storage processing circuitry 142 writes host data 122 into and retrieves host data 122 from the set of storage devices 144 in response to the I/O requests 120. During such operation, the connectivity client 146 provides the trusted connectivity 150 between the data storage equipment 104 and the data center 106. To create such trusted connectivity 150, the connectivity client 146 and the data center 106 perform various handshaking/validation operations to establish trust. Once the trusted connectivity 150 is in place, the data center 106 is able to carry out a variety of rich and reliable operations such as deploying software/updates/etc., performing user operations, monitoring/evaluating telemetry, troubleshooting, and so on. Further details will now be provided with reference to FIG. 2.

FIG. 2 is a sequence diagram 200 showing certain activities for the electronic setting 100 (FIG. 1) in accordance with certain embodiments. As shown in FIG. 2, the data storage equipment 104 and the data center 106 are able to electronically communicate with each other (also see the communications medium 108 in FIG. 1).

The storefront server 160 and the set of management servers 162 are shown separately in FIG. 2 to illustrate that the components of the data center 106 may reside at different locations and/or exchange internal communications. Accordingly, the connectivity client 146 storefront server 160 and the set of management servers 162 may communicate with each other as well (e.g., through the communications medium 108, through a separate and/or dedicated computer network, etc.).

Prior to the activities of the sequence diagram 200, a human user (e.g., an administrator or operator) may install and activate specialized code for the connectivity client 146 (e.g., thus embedding/launching/etc. the connectivity client 146 within the storage equipment 104). Similarly, specialized code may be invoked at the data center 106.

In the context of one or more processors executing software, computer program products are capable of delivering all or portions of the software constructs to various electronic circuitry. Such computer program products have non-transitory (or non-volatile) computer readable media which store sets of instructions that control operations of the electronic circuitry. Examples of suitable computer readable storage media include tangible articles of manufacture and apparatus which store instructions in a non-volatile manner such as DVD, CD-ROM, flash memory, disk memory, tape memory, and the like.

At 210, the connectivity client 146 receives a startup command 212. Such a startup command 212 may be input into the data storage equipment 104 locally by a human user (e.g., an administrator or operator).

At 212, the connectivity client 146 generates a token. Such a token may be based on a set of public and/or private keys.

At 214, the token is sent from the connectivity client 146 to the storefront server 160 through first connectivity. Here, the connectivity client 146 is not yet trusted by the data center 106 (i.e., the first connectivity is untrusted). In some arrangements, the connectivity client 146 sends the token electronically to the storefront server 160. In other arrangements, the human user may further interact to convey the token to the storefront server 160 (e.g., via an exchange with a webpage, portal, app, or the like).

At 220, the storefront server 160 provides the token to the set of management servers 162 for processing. In some arrangements, the communications between the storefront server 160 and the set of management servers 162 may be direct (e.g., when the storefront server 160 and the set of management servers 162 reside or are integrated within the same equipment or facility). In other arrangements, the communications between the storefront server 160 and the set of management servers 162 may be less direct (e.g., when the storefront server 160 and the set of management servers 162 are in different facilities or are separated by a public network, and so on).

Upon receipt of the token and at 222, the set of management servers 162 processes the token and generates a unique identifier (or ID) which the set of management servers 162 associates with the connectivity client 146 that provided the token. The set of management servers 162 further generates a client ID to uniquely identify the connectivity client 146 among other connectivity clients 146 and a set of credentials (e.g., a voucher) for use in generating trust with the connectivity client 146.

It should be appreciated that the client ID and/or the set of credentials may be derived from the unique ID (e.g., a resource ID, a secret, a hash, a key, combinations thereof, etc.) to enable the connectivity client 146 to derive the same unique ID on its end without the unique ID being exposed. A Diffie-Hellman (DH) key exchange or a similar secret sharing mechanism is suitable for this process.

In some arrangements, the set of management servers 162 maintains a registration repository (or database) 230 and the set of management servers 162 creates and updates a new entry in the repository 230 (e.g., see the double arrow 232 in FIG. 2). The new entry may use the client ID as the identifier (e.g., as an index, key, etc.) and store a variety of information (e.g., public and/or private keys used to generate the set of credentials and which may or may not be publicly exposed, descriptive information, timestamps, etc.). It should be appreciated that storing the unique ID within the repository 230 (e.g., at least temporarily with a time-to-live or TTL value) will enable any of the set of management servers 162 to later access the unique ID and thus effectively and appropriately respond to subsequent communications from the connectivity client 146.

Next, at 234, the set of management servers 162 returns the client ID and the set of credentials to the storefront server 160. In some arrangements, the set of credentials remains valid for only a short period of time (e.g., based on the TTL value) to prevent subsequent unauthorized use later on.

At 236, the storefront server 160 sends the client ID and the set of credentials to the connectivity client 146. Since the connectivity client 146 has communicated only with the storefront server 160, the connectivity client 146 may be unaware of the exchange between the storefront server 160 and the set of management servers 162, etc. (i.e., the participation of the set of management servers 162 has at least thus far been transparent to the connectivity client 146).

In some arrangements, the client ID and the set of credentials (e.g., a voucher) are combined to form an installkey that can be passed back to the connectivity client 146. Although such an installkey may be exposed, the unique ID maintained by the set of management servers 162 is not exposed.

At 240, upon delivery of the client ID and the set of credentials to the connectivity client 146, the connectivity client 146 generates further validation/authentication information. Along these lines, the connectivity client 146 ascertains the unique ID (or generates a derivative result of the unique ID) which is maintained by the set of management servers 162. At this point, the data storage equipment 104 and the data center 106 have the unique ID. In some arrangements, the connectivity client 146 performs one side of a DH key exchange or utilizes a similar secret sharing mechanism to obtain the unique ID.

In some arrangements, the client ID and the set of credentials take the form of an installkey which is received directly by the connectivity client 146. In other arrangements, the human user receives the installkey and inputs the installkey into the connectivity client 146 for additional security (e.g., as out-of-band input which is then manually entered into the data storage equipment 104).

Then, the data storage equipment 104 and the data center 106 perform a series of exchanges to establish trusted connectivity therebetween. That is, at 250, the connectivity client 146 communicates directly with the set of management servers 162 rather than the storefront server 160 beginning with a series of handshaking and validation communications. Such communications may involve the connectivity client 146 sending an untrusted announcement message to the set of management servers 162, and the set of management servers 162 responding with a challenge message.

In response to the challenge, the connectivity client 146 may sign the unique ID (e.g., using the same set of public and/or private keys used to generate the initial token that the connectivity client 146 sent to the storefront server 160 at 214). The connectivity client 146 may then send the signed unique ID and/or other corroborating credentials to the set of management servers 162. Such a derivative result is an indication that the connectivity client 146 possesses access to the unique ID for validation purposes.

At 244, still as part of the handshaking/validation process, the set of management servers 162 ascertains authenticity of the connectivity client 146. Such a determination may be made algorithmically from the signed unique ID and the unique ID maintained at the set of management servers 162 (e.g., see the repository 230). Along these lines, the set of management servers 162 checks whether such delivery of the signed unique ID substantiates that the connectivity client 146 has the same set of public and/or private keys used to generate the initial token, determines whether there is a unique ID match, checks the TTL to verify that the opportunity to generate trust has not expired, combinations thereof, and so on.

At 250, the connectivity client 146 and the set of management servers 162 confirm that the trusted connectivity 150 (FIG. 1) has been established between the data storage equipment 104 and the data center 106. Along these lines, with signature verification and/or positive outcomes from handshaking/validation, the set of management servers 162 updates it records (e.g., see the repository 230) to persist the established trustworthiness of the connectivity client 146. Likewise, the connectivity client 146 updates its records and is ready to communicate with the set of management servers 162 over the established trusted connectivity.

Some of the record keeping may involve electronically cleaning up temporarily used credentials (e.g., a resource ID, temporary credentials, etc.), and establishing use of more permanent (or persistent) credentials. It should be appreciated that, although the connectivity client 146 was initially untrusted, the connectivity client 146 is now registered as trusted by the data center 106.

At 260, the connectivity client 146 and the set of management servers 162 utilize the established trusted connectivity 150 to perform useful work. Such activities may include deploying software/updates/etc., performing user operations, monitoring/evaluating telemetry, troubleshooting, combinations thereof, and so on.

It should be understood that, once such persisted trust has been established between the connectivity client 146 and the set of management servers 162, the ability to create and utilize one or more trusted connections between the storage equipment 104 and the data center 106 remains and survives over time. For example, a network failure may cause a temporary loss or break in a particular trusted network connection. Nevertheless, the storage equipment 104 and the data center 106 are able to re-establish the trusted network connection (e.g., reconnect securely) since both the connectivity client 146 and the set of management servers 162 have completed handshaking and validation to develop their persisted trusted connectivity relationship. Accordingly, they are able to continue their zero trust connectivity communications (highly secure connectivity in which there is zero trust outside the communications realm between the storage equipment 104 and the data center 106).

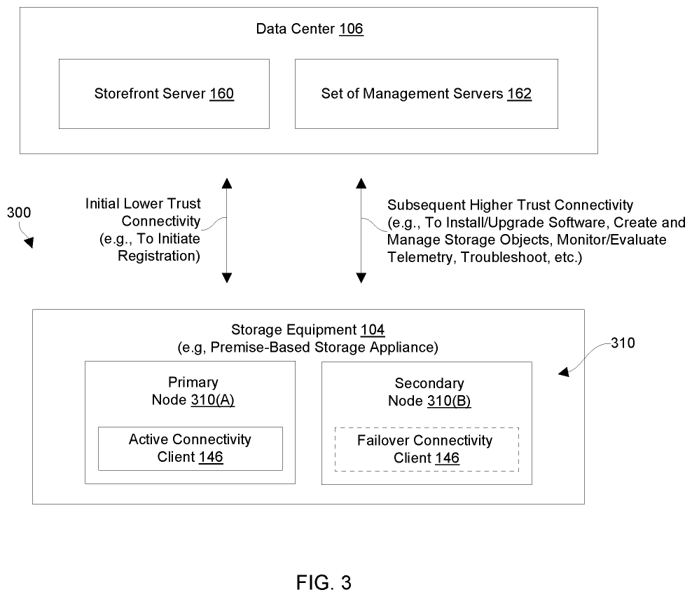

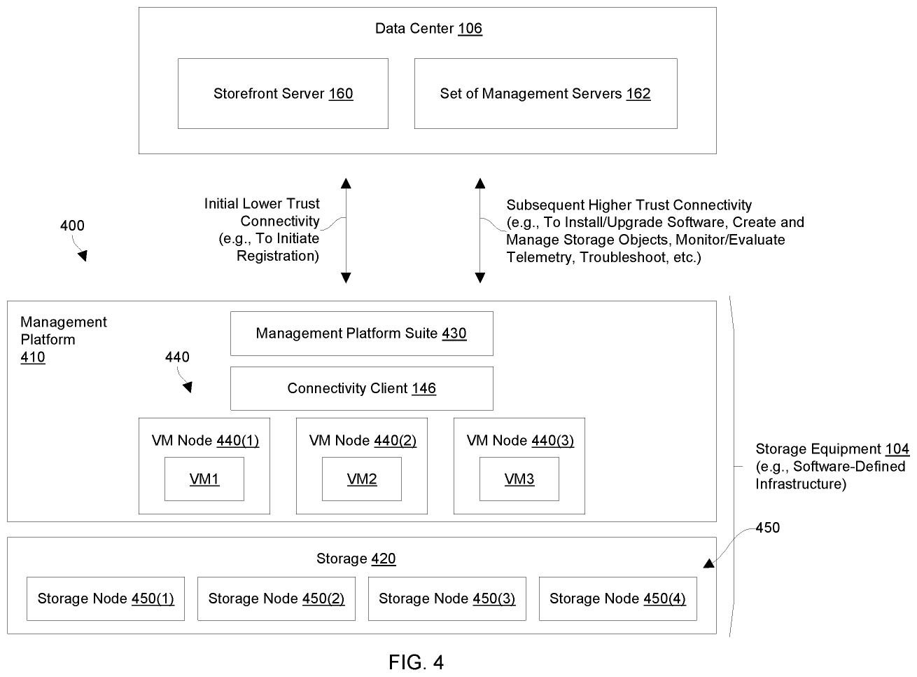

It should be appreciated that the sequence diagram 200 is suitable for a variety of different use cases. For example, in one use case, a storage equipment manufacturer may own and operate the data center 106 thus enabling the data center 106 to enjoy and/or advantageously access various resources of the manufacturer. In another use case, a customer of the manufacturer may own and operate the data center 106 thus enabling that customer to independently offer services initially via the storefront server 160. Further details will now be provided with reference to FIGS. 3 and 4.

FIGS. 3 and 4 show example storage equipment platforms which include connectivity clients 146 (also see FIGS. 1 and 2). FIG. 3 shows a first example storage platform 300 which is suitable for certain embodiments. FIG. 4 shows a second example storage platform 400 which is suitable for certain embodiments.

As shown in FIG. 3, the example storage platform 300 takes the form of premise-based storage appliance equipment. That is, the storage equipment 104 may reside at a customer location, at a server farm (or at a data center of its own), and/or as other on-premises equipment.

Along these lines, the storage equipment 104 includes multiple nodes 310 such as a primary node 310(A) and a secondary node 310(B) which are capable of hosting the connectivity client 146. In particular, the connectivity client 146 may take the form of specialize circuitry (e.g., processing circuitry running in accordance with specialized code) on the primary node 310(A).

At some point, if the primary node 310(A) encounters a failure, the secondary node 310(B) may step in to continue operation (e.g., high availability). In this situation, the connectivity client 146 may failover to the secondary node 310(B) such that the connectivity client 146 is then hosted by the secondary node 310(B).

Accordingly, the storage equipment 104 continues to enjoy trusted connectivity with the data center 106. In fact, the data center 106 may detect the failure remotely through the trusted connectivity 150 (FIG. 1) and take remedial action (e.g., output an alert, troubleshoot the failure, download a fix, and so on).

As shown in FIG. 4, the example storage platform 400 takes the form of software-defined infrastructure with high resiliency/redundancy/scalability/etc. That is, the storage equipment 104 may reside at a centralized installation which may be accessed (or shared) by one or more customers. Such infrastructure provides convenient scalability and other features that may be transparent to customers (e.g., containerization, virtualization, load balancing, fault tolerance, combinations thereof, etc.).

Along these lines, the storage equipment 104 includes a management platform 410 and storage 420. The management platform 410 includes a management platform suite of applications 430, the connectivity client 146, and virtual machine (VM) nodes 440(1), 440(2), 440(3) (collectively, VM nodes 440) running VM1, VM2, VM3 (collectively, VMs). Although three VM nodes 440 are shown, it should be understood that any number of VM nodes 440 are suitable for use. In some arrangements, the VM nodes 440 are implemented as worker machines in Kubernetes (e.g., containers, pods, etc.) providing microservices in a clusterized environment.

The storage 420 includes multiple storage nodes 450(1), 450(2), 450(3), 450(4) (collectively, storage nodes 450). Although four storage nodes 450 are shown, it should be understood that any number of storage nodes 450 are suitable for use. In some arrangements, the storage nodes 450 utilize a meta data manager (MDM)/storage data server (SDS) architecture (e.g., in which VMs host the MDM and/or SDS roles).

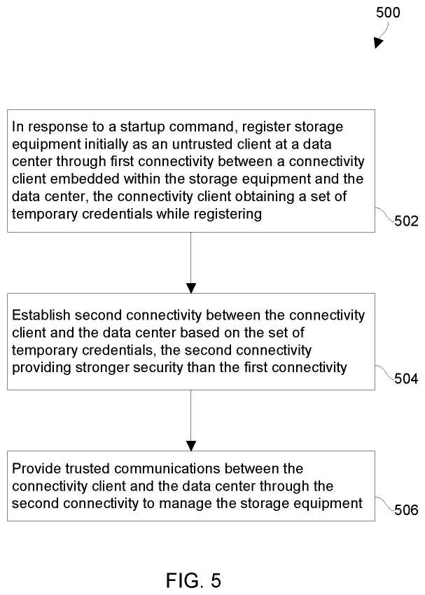

Accordingly, the storage equipment 104 enjoys trusted connectivity with the data center 106 during operation. For example, the data center 106 may monitor operation of the storage equipment 104 and issue management commands (e.g., user commands such as those to create new volumes, etc.) to the storage equipment 104 through the trusted connectivity 150 (FIG. 1). Further details will now be provided with reference to FIG. 5.

FIG. 5 is a flowchart of a procedure 500 to operate storage equipment in accordance with certain embodiments. Such a procedure 500 is reliable, secure, and can then be leveraged to then operate the storage equipment in a rich and reliable manner (e.g., deploy updates, monitor/evaluate equipment health/events/etc., troubleshoot, combinations thereof, and so on).

502 involves, in response to a startup command, registering the storage equipment initially as an untrusted client at a data center through first connectivity between a connectivity client embedded within the storage equipment and the data center (also see 210 through 236 in FIG. 2). Along these lines, the connectivity client obtains a set of temporary credentials while registering.

504 involves establishing second connectivity between the connectivity client and the data center based on the set of temporary credentials (also see 240 through 250 in FIG. 2). The second connectivity provides stronger security than the first connectivity. That is, although the connectivity client was initially untrusted, the connectivity client is now registered as trusted by the data center.

506 involves, after establishing the second connectivity between the connectivity client and the data center, providing trusted communications between the connectivity client and the data center through the second connectivity to manage the storage equipment (also see 260 in FIG. 2). Such trusted communications may effectively and efficient operate certain or all aspects of the storage equipment.

As described above, improved techniques are directed to operating storage equipment 104 which involve establishing and utilizing trusted connectivity between the storage equipment 104 and a data center 106. Such trusted connectivity is formed in response to registration (e.g., deployment of a set of temporary credentials, using the set of temporary credentials in an exchange to establish zero trust connectivity, etc.). Once such trusted connectivity is established, the data center 106 is able to carry out a variety of rich and reliable operations such as providing software/updates/etc., performing user operations, monitoring/evaluating telemetry, troubleshooting, and so on via the trusted connectivity.

While various embodiments of the present disclosure have been particularly shown and described, it will be understood by those skilled in the art that various changes in form and details may be made therein without departing from the spirit and scope of the present disclosure as defined by the appended claims.

As disclosed herein, multiple components (client, server, registration portal) coordinate to establish the trusted connection for the client and server going forward. The process is reliable, secure, and can then be leveraged for a variety of operations (e.g., software updates, monitoring, remote management, etc.). Complexity and inconsistency are removed, and the process is well-suited for all setups between equipment in the field and a central office.

Additionally, it should be understood that various components of the electronic setting 100 such as the host computers 102 are capable of being implemented in or “moved to” the cloud, i.e., to remote computer resources distributed over a network. Here, the various computer resources may be distributed tightly (e.g., a server farm in a single facility) or over relatively large distances (e.g., over a campus, in different cities, coast to coast, etc.). In these situations, the network connecting the resources is capable of having a variety of different topologies including backbone, hub-and-spoke, loop, irregular, combinations thereof, and so on. Additionally, the network may include copper-based data communications devices and cabling, fiber optic devices and cabling, wireless devices, combinations thereof, etc. Furthermore, the network is capable of supporting LAN-based communications, SAN-based communications, combinations thereof, and so on.

It should be appreciated that with certain conventional data storage system there are services that do not provide zero trust connectivity. Moreover, such systems may require several poorly-defined steps to register and establish connectivity which still may be inconsistent and unreliable.

In accordance with certain embodiments, a connectivity module client is embedded into storage equipment to establish zero trust connectivity to remote digital services. The client then establishes secure zero trust connections through automated registration, and provides real-time connectivity (e.g., “always on” trusted connectivity versus dial homes connectivity). That is, such embodiments are able to establish secure zero trust connectivity from equipment installations in the field to remote digital services to then provide support and services.

It should be understood that, prior to certain improvements disclosed herein, certain tools and methodologies lacked zero trust connectivity capabilities. Along these lines, conventional equipment either doesn't have these capabilities or may require complex steps to establish secure connectivity. Moreover, such conventional equipment does not offer faster real-time connection to the digital services for obtaining telemetry, troubleshooting and remediation.

However, in accordance with certain embodiments, there is establishment of end to end secure zero trust connectivity between clients and aggregators running digital services. This secure connection is then used to manage infrastructure such as to deploy software, perform user operations such as create volume through that secure connectivity and for telemetry. In addition, the secure connection can be used by such digital services to perform diagnostics, troubleshooting, and remediation.

In accordance with certain embodiments, a client container is running as one of the services in the operating system (OS). During the installation of the initial software into the hardware, the client service starts up and automatically establishes a connection to an Aggregator with the predefined details and obtains a temporary client ID and temporary certificates. Once the client connection is established as untrusted client, a series of handshake and validation events occur to establish secure zero trust connectivity to aggregators. The client is then trusted in the aggregator connections list. The trusted connection is used to manage the storage equipment and/or provide health telemetry back to digital services.

Like the earlier-described initial software into the hardware and in accordance with other embodiments, integration includes running client(s) that is (are) deployed during initial setup and run as a microservice (e.g., in a Kubernetes Atlantic Cluster). At startup, the client establishes a connection to the Aggregator as untrusted client, then goes through a series of handshakes to establish a trusted connection. This trusted connection is then used to perform storage management operations, manage the cluster itself, and provide health telemetry back to the digital services, combinations thereof, etc.

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document. Such modifications and enhancements are intended to belong to various embodiments of the disclosure.

What is claimed is:

1. A method of operating storage equipment, the method comprising:
in response to a startup command, registering the storage equipment as an untrusted client at a data center through first connectivity between a connectivity client embedded within the storage equipment and the data center, the connectivity client obtaining a set of temporary credentials while registering;
establishing second connectivity between the connectivity client and the data center based on the set of temporary credentials, the second connectivity providing stronger security than the first connectivity; and
after establishing the second connectivity between the connectivity client and the data center, providing trusted communications between the connectivity client and the data center through the second connectivity to manage the storage equipment.

2. The method of claim 1 wherein the data center includes a storefront server;
wherein the first connectivity includes a first connection between the connectivity client and the storefront server; and
wherein registering the storage equipment as an untrusted client at the data center through the first connectivity includes:
delivering a temporary identifier and a temporary certificate from the storefront server to the connectivity client through the first connection between the connectivity client and the storefront server of the data center.

3. The method of claim 2 wherein the data center further includes a set of management servers that is different from the storefront server; and
wherein establishing the second connectivity includes:
creating, as at least part of the second connectivity, a second connection between the connectivity client and the set of management servers of the data center, the second connection being different from the first connection.

4. The method of claim 3 wherein creating the second connection between the connectivity client and the set of management servers of the data center includes:
based on the set of temporary credentials obtained by the connectivity client while registering, performing handshaking and validation operations between the connectivity client and the set of management servers to form a trusted connection as the second connection.

5. The method of claim 4 wherein providing the trusted communications between the connectivity client and the data center includes:
deploying storage equipment software from the set of management servers to the storage equipment through the trusted connection and the connectivity client, the storage equipment software being constructed and arranged to install and operate on the storage equipment to process input/output (I/O) requests on behalf of a set of host computers.

6. The method of claim 4 wherein providing the trusted communications between the connectivity client and the data center includes:
providing a set of user commands from the set of management servers to the storage equipment through the trusted connection and the connectivity client, the set of user commands being constructed and arranged to create a set of storage objects which hold host data on the storage equipment.

7. The method of claim 4 wherein providing the trusted communications between the connectivity client and the data center includes:
conveying storage equipment performance metrics from storage equipment to the set of management servers through the connectivity client and the trusted connection, the storage equipment performance metrics identifying operating details of the storage equipment.

8. The method of claim 4 wherein providing the trusted communications between the connectivity client and the data center includes:
performing storage equipment troubleshooting operations on the storage equipment from the set of management servers through the trusted connection and the connectivity client, the storage equipment troubleshooting operations being constructed and arranged to diagnose and remediate anomalies on the storage equipment.

9. The method of claim 4 wherein providing the trusted communications between the connectivity client and the data center includes:
deploying storage equipment software from the set of management servers to the storage equipment through the trusted connection and the connectivity client, the storage equipment software being constructed and arranged to install and operate on the storage equipment to process input/output (I/O) requests on behalf of a set of host computers;
conveying storage equipment performance metrics from storage equipment to the set of management servers through the connectivity client and the trusted connection, the storage equipment performance metrics identifying operating details of the storage equipment;
providing a set of user commands from the set of management servers to the storage equipment through the trusted connection and the connectivity client, the set of user commands being constructed and arranged to create a set of storage objects which hold host data on the storage equipment; and
performing storage equipment troubleshooting operations on the storage equipment from the set of management servers through the trusted connection and the connectivity client, the storage equipment troubleshooting operations being constructed and arranged to diagnose and remediate anomalies on the storage equipment.

10. The method of claim 4 wherein the storage equipment is disposed at a storage equipment location;
wherein the data center resides at a set of remote locations that is different from the storage equipment location;
wherein the connections extend over a public network that connects the storage equipment location with the set of remote locations; and
wherein providing the trusted communications between the connectivity client and the data center includes:
electronically managing the storage equipment from the data center through at least some of the connections that extend over the public network.

11. The method of claim 10 wherein the storage equipment includes:
primary storage processing circuitry which includes an operating instance of the connectivity client, and
secondary storage processing circuitry which includes a backup instance of the connectivity client to enable the connectivity client to continue operation in response to a failover event in which the primary storage processing circuitry encounters a failure while the secondary storage processing circuitry remains operational and the backup instance of the connectivity client takes over on behalf of the operating instance of the connectivity client.

12. The method of claim 10 wherein the storage equipment includes:
a set of storage data server (SDS) nodes, and
a management platform coupled with the set of SDS nodes, the management platform including the connectivity client and being constructed and arranged to run a set of containerized applications to store data within the set of SDS nodes on behalf of a set of host computers.

13. The method of claim 4 wherein registering the storage equipment as an untrusted client at the data center through the first connectivity further includes:
conveying an installation token from the connectivity client from the storefront server to the set of management servers,
based on the installation token, generating the temporary identifier and the temporary certificate in the set of management servers, and
conveying the temporary identifier and the temporary certificate from the set of management servers to the storefront server for delivery from the storefront server to the connectivity client.

14. The method of claim 13 wherein registering the storage equipment as an untrusted client at the data center through the first connectivity further includes:
prior to delivering the temporary identifier and the temporary certificate from the storefront server to the connectivity client, storing the temporary identifier and the temporary certificate in the set of management servers to enable the set of management servers to perform the handshaking and validation operations to form the trusted connection.

15. The method of claim 14, further comprising:
prior to registering the storage equipment as an untrusted client at the data center, installing and activating the connectivity client on the storage equipment.

16. Storage equipment, comprising:
a set of storage devices constructed and arranged to store data; and
storage equipment circuitry coupled with the set of storage devices, the storage equipment circuitry being constructed and arranged to provide a connectivity client and perform a method of:
in response to a startup command, registering the storage equipment as an untrusted client at a data center through first connectivity between the connectivity client and the data center, the connectivity client obtaining a set of temporary credentials while registering;
establishing second connectivity between the connectivity client and the data center based on the set of temporary credentials, the second connectivity providing stronger security than the first connectivity; and
after establishing the second connectivity between the connectivity client and the data center, providing trusted communications between the connectivity client and the data center through the second connectivity to manage the storage equipment.

17. Data center equipment, comprising:
a set of management servers constructed and arranged to manage storage equipment; and
data center circuitry coupled with the set of management servers, the data center circuitry being constructed and arranged to perform a method of:
in response to a startup command, registering the storage equipment as an untrusted client at the data center through first connectivity between a connectivity client embedded within the storage equipment and the data center, the connectivity client obtaining a set of temporary credentials while registering;
establishing second connectivity between the connectivity client and the data center based on the set of temporary credentials, the second connectivity providing stronger security than the first connectivity; and
after establishing the second connectivity between the connectivity client and the data center, providing trusted communications between the connectivity client and the data center through the second connectivity to enable the set of management servers to manage the storage equipment.

18. A computer program product having a non-transitory computer readable medium which stores a set of instructions to operate storage equipment; the set of instructions, when carried out by computerized circuitry, causing the computerized circuitry to perform a method of:
in response to a startup command, registering the storage equipment as an untrusted client at a data center through first connectivity between a connectivity client embedded within the storage equipment and the data center, the connectivity client obtaining a set of temporary credentials while registering;
establishing second connectivity between the connectivity client and the data center based on the set of temporary credentials, the second connectivity providing stronger security than the first connectivity; and
after establishing the second connectivity between the connectivity client and the data center, providing trusted communications between the connectivity client and the data center through the second connectivity to manage the storage equipment.
